(19) United States
(12) Patent Application Publication
(10) Pub. No.: US 2016/0356328 A1
(43) Pub. Date: Dec. 8, 2016

(54) Hydrodynamic Retarder

(71) Applicant: VOITH PATENT GMBH, Heidenheim (DE)

(72) Inventor: Dieter LAUKEMANN, CRAILSHEIM (DE)

(21) Appl. No.: 15/117,831

(22) PCT Filed: Jan. 29, 2015
(86) PCT No.: PCT/EP2015/051776

§ 371 Date: Aug. 10, 2016

(30) Foreign Application Priority Data
Feb. 10, 2014 (DE) 10 2014 202 366.1

(51) Int. Cl. F16D 57/04; B60T 10/02; F04D 29/24

(52) U.S. Cl. CPC F16D 57/04; F04D 29/24; B60T 10/02

(57) ABSTRACT

A hydrodynamic machine has a vaned primary wheel and a vaned secondary wheel, which together form a toroidal working chamber filled with a working medium to form a hydrodynamic circuit flow for transmission of a drive moment. One of the two vaned wheels is driven by a drive shaft of the hydrodynamic machine via a rotary axis. The machine further has a side channel pump having a pump impeller with a plurality of pump vanes and a channel running in the circumferential direction of the pump impeller. The pump vanes are arranged in the channel such that when the pump impeller rotates, a delivery effect is generated in the channel such that at an inlet end a suction effect and at an outlet end a pressure effect is generated. The pump impeller is radially mounted, axially moveably and/or angularly tilt ably, rotationally fixedly on the drive shaft.

The present invention concerns a hydrodynamic machine, in particular a hydrodynamic retarder according to the preamble of claim 1.

DE 10 2006 021 331 A1 describes a generic hydrodynamic machine, in particular a hydrodynamic retarder, in which, to reduce the fill level of the working chamber in non-braking operation, an extraction device is provided in the form of a so-called side channel pump which is connected to the working chamber of the hydrodynamic retarder in such a manner that working medium can be conducted, in order to actively extract working medium from the working chamber. Such a side channel pump has a pump impeller with a plurality of pump vanes, and a channel running in the circumferential direction of the pump impeller and hence in the circumferential direction of the hydrodynamic machine, with an inlet end and an outlet end, wherein the pump vanes are arranged in or relative to the channel such that on rotation of the pump impeller, a delivery effect is generated in the channel in order to draw through working medium and/or a mixture of working medium and air from the working chamber of the hydrodynamic retarder in non-braking operation. Accordingly, an inlet end of the channel of the side channel pump is connected to the working chamber in such a manner that working medium can be conducted.

According to DE 10 2006 021 331 A1, it is proposed to configure the pump impeller of the side channel pump either of one piece with the primary wheel of the hydrodynamic retarder, or to mount the pump impeller on a journal in the retarder housing and drive this via a form fit engagement with the drive shaft of the retarder. A cantilever mounting of the pump impeller on the retarder drive shaft is also mentioned.

Corresponding mountings are also described in DE 10 2008 049 283 A1.

In practice, the mounting of the pump impeller of the side channel pump in the retarder housing has become common. By means of this mounting in the retarder housing in which the channel of the side channel pump is also formed, very small gaps can be ensured between the pump impeller and the housing for sealing the channel, wherein usually additionally sealing rings, for example rectangular rings, are provided in the gaps in order to prevent pressure losses. A disadvantage of the design is that the known mounting of the side channel pump is susceptible to dry running and thus failures can occur.

The present invention is therefore based on the object of specifying a hydrodynamic machine with a side channel pump in which the reliability of the side channel pump can be improved without reducing the possibility of producing minimal gaps between the pump impeller and the sealing faces in the housing.

The object of the invention is achieved by a hydrodynamic machine with the features of claim 1. The dependent claims describe advantageous and particularly suitable embodiments of the invention.

A hydrodynamic machine according to the invention, which in particular is configured as a hydrodynamic retarder—wherein the invention may however for example also be applied in hydrodynamic clutches or hydrodynamic converters—has a vaned primary wheel and a vaned secondary wheel, which together form a toroidal working chamber that can be filled with a working medium in order to form therein a hydrodynamic circuit flow for transmission of a drive moment, or a braking moment in a hydrodynamic retarder. At least one of the two vaned wheels, for example the primary wheel, is driven by a drive shaft of the hydrodynamic machine, in particular the hydrodynamic retarder. For example, it is configured integrally with the drive shaft or is carried thereby is a separate component.

When the hydrodynamic machine is configured as a hydrodynamic retarder, the vaned secondary wheel may be configured as a stator, i.e. non-rotating, or as a so-called contra-rotating rotor, i.e. it is driven in the opposite direction to the primary wheel. In an embodiment of the hydrodynamic machine as a hydrodynamic clutch, the secondary wheel drives an output, in particular an output shaft, as it does when configured as a hydrodynamic converter.

According to the invention, a side channel pump is provided comprising a pump impeller with a plurality of pump vanes and a channel running in the circumferential direction of the pump impeller, with an inlet end and an outlet end, as specified in detail for example in DE 10 2006 021 331 A1 cited initially. The channel is for example formed in the housing of the hydrodynamic machine, i.e. the channel walls are formed by the housing of hydrodynamic machine or by a component inserted therein.

The pump vanes of the pump impeller of the side channel pump are arranged circumferentially in or relative to the channel such that on rotation of the pump impeller, a delivery effect is generated in the channel. This delivery effect causes a suction effect at the inlet end of the channel and a pressure effect at the outlet end. Accordingly, now the inlet end can be connected to the working chamber of the hydrodynamic machine in such a manner that working medium can be conducted, in order to extract working medium or a mixture of working medium and air. This may take place in idle operation of hydrodynamic machine, or in non-braking operation of a hydrodynamic retarder. In principle however, if advantageous, such an extraction may also take place in braking operation of the hydrodynamic retarder or generally in nominal operation or part-load operation of the hydrodynamic machine.

In principle, the side channel pump may also be used to deliver working medium into the working chamber, in that the outlet end of the channel is connected to the working chamber. In relation to the operating state in which such delivery takes place, the statements made above on extraction apply.

According to the invention now the pump impeller is radially mounted, axially moveably and/or angularly tiltably, rotationally fixedly on the drive shaft of the hydrodynamic machine. Thus a torque transmission from the drive shaft to the pump impeller of the side channel pump is ensured, and also an axial shift and/or angular offset of the pump impeller on the drive shaft is possible. Because of the radial mounting of the pump impeller on the drive shaft, the pump impeller cannot however move relative to the drive shaft in the radial direction or in a plane perpendicular to the drive shaft or its rotational axis, and is advantageously always positioned concentrically thereto.

Particularly advantageously, the pump impeller is axially mounted against the housing of the hydrodynamic machine, which in particular is configured as a stationary, i.e. non-rotating, housing. Usually, the housing surrounds at least the vaned wheel driven by the drive shaft, for example the primary wheel. In a retarder with the secondary wheel configured as a stator, this is for example mounted stationarily in the housing or is formed thereby. In an embodiment as a hydrodynamic clutch, the housing as a stationary housing may surround both impellers or rotate together with one of the two impellers and surround the second impeller.

The axial mounting of the pump impeller in the housing of the hydrodynamic machine in particular allows very small gaps to be created between the pump impeller and the housing in which advantageously the channel of the side channel pump is formed, which leads to a high efficiency of the side channel pump.

The pump impeller of the side channel pump is advantageously mounted on the drive shaft via a curved-tooth coupling. Such a curved-tooth coupling advantageously allows said axial shift and/or angular offset of the pump impeller on the drive shaft.

According to a particularly preferred embodiment, the curved-tooth coupling has a first gear ring with external toothing and a second gear ring with internal toothing, wherein the two gear rings surround each other in the radial direction so that the internal toothing meshes with the external toothing in a plane running perpendicular to the rotary axis or drive shaft. In the case of an angular mounting, the plane may also run at an angle to the rotary axis.

One of the two gear rings, in particular the first gear ring, may be mounted on or configured integrally with the drive shaft, and the other of the two gear rings, in particular the second gear ring, may be mounted on or configured integrally with the pump impeller of the side channel pump.

It is particularly favorable if the external toothing has teeth with a crowned tooth head. The internal toothing may then have tooth gaps with a concave tooth base, which in particular is configured complementary to the crowned tooth head, or with a flat tooth base or one which is rectilinear or flat at least in the direction of the rotary axis, in order to allow the desired angular offset capacity of the pump impeller on the drive shaft. According to one embodiment, the tooth base of the internal toothing, the external toothing and/or the tooth head of the internal toothing, is configured curved.

According to an advantageous embodiment of the invention, the pump impeller is sealed against the housing by means of at least one slip ring, in particular in the axial direction. The axial direction corresponds to the direction of the rotary axis of the hydrodynamic machine or to that of its drive shaft.

It is particularly favorable if the slip ring is carried moveably in the axial direction by the pump impeller or the housing, in order to bridge relative movements in operation or tolerances in production.

For example, the slip ring is connected rotationally fixedly to the pump impeller or the housing, and fixed in particular by form fit by means of at least one undercut. Evidently, a friction connection or material fit may also considered. For example, the torque support may take place by form fit via tabs on the slip ring which rest in recesses on the pump impeller or on the housing.

The slip ring and/or the pump impeller may be made of plastic. In the latter case in particular, a separate axial bearing for axially mounting the pump impeller in the housing may be omitted.

For example, one of the two gear rings, in particular the first gear ring with the external toothing, is pressed onto a journal of the drive shaft after it has been produced separately therefrom, in particular as a sintered part.

The invention will now be described as an example below with reference to an exemplary embodiment.

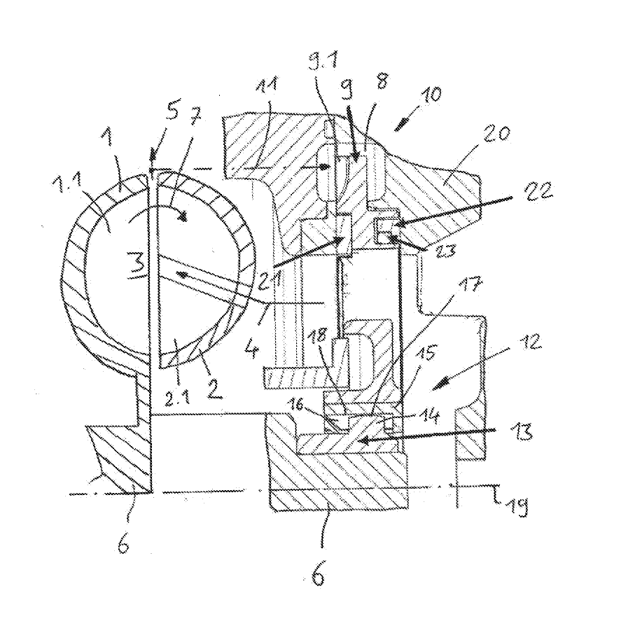

FIG. 1 shows in a diagrammatic depiction a hydrodynamic machine according to the invention with a primary wheel 1 and a secondary wheel 2. The primary wheel 1 has a plurality of primary wheel vanes 1.1, and the secondary wheel 2 has a plurality of secondary wheel vanes 2.1, which are positioned in a common working chamber 3 formed by the primary wheel 1 and the secondary wheel 2. The working medium is supplied to the working chamber 3 via a working medium supply 4, and extracted therefrom via a working medium outlet 5. The working medium outlet 5 is depicted merely diagrammatically and could for example run through the secondary wheel 2. The rotational drive of the primary wheel 1 by means of the drive shaft 6 creates a hydrodynamic circuit flow of the working medium in the working chamber 3, see arrow 7.

In order in particular to be able to create a reduced pressure in the working chamber 3 when the hydrodynamic machine is switched off or at idle, this is connected working-medium-conductively to the channel 8 or an inlet end of the channel 8 (not shown in detail here) of a side channel pump 10. The delivery effect is generated by rotation of the pump impeller 9 of the side channel pump 10 in the channel 8. Although not shown here, according to a particular embodiment a valve may also be provided in the working-medium-conductive connection 11 between the working chamber 3 and the channel 8 of the side channel pump 10, in order to optionally open and close this working-medium-conductive connection 11.

In the exemplary embodiment shown, the pump vanes 9.1 of the pump impeller 9 are formed in the axial direction laterally on the pump impeller 9, in particular such that they generate an axial-radial flow. This could however also be different.

The pump impeller 9 is radially mounted via a curved-tooth coupling 12 on the drive shaft 6. The curved-tooth coupling 12 has a first gear ring 13 with external toothing 14 and a second gear ring 15 with internal toothing 16. The external toothing 14, as shown, has a crowned tooth head 17, whereas the internal toothing 16, viewed in the direction of the rotary axis 19 of the drive shaft 6, has a rectilinear or flat tooth base 18. Thus the second gear ring 15 may tilt on the convex tooth head 17 in order to compensate for movements of the drive shaft 6 relative to the housing 20 of the hydrodynamic machine.

In order to keep the pump impeller 9 always aligned in the desired position relative to the housing 20, in particular to prevent an axial shift of the pump impeller 9 relative to the housing 20, it is axially mounted in the housing 20 via an axial bearing 21, here in the form of a plain bearing. This axial bearing 21 may also create a seal between the axial side of the pump impeller 9 and the housing 20. In the exemplary embodiment shown, on the other axial side of the pump impeller 9, a slip ring 22 is inserted in the pump impeller 9 which is moveable relative to the housing 20 under elastic pretension in the axial direction i.e. in the direction of the rotary axis 19. In the exemplary embodiment shown, the slip ring 22 is also sealed via an O-ring 23 against the surface of the recess in the pump impeller 9.

1-10. (canceled)

11. A hydrodynamic machine, comprising:
two vaned wheels including a vaned primary wheel and a vaned secondary wheel which together form a toroidal working chamber being filled with a working medium to form therein a hydrodynamic circuit flow for transmission of a drive moment;
a drive shaft having a rotary axis for driving at least one of said two vaned wheels;
a side channel pump having a pump impeller with a plurality of pump vanes and a channel running in a circumferential direction of said pump impeller, said channel having an inlet end and an outlet end, said pump vanes are disposed in or relative to said channel such that on rotation of said pump impeller, a delivery effect is generated in said channel such that at said inlet end a suction effect and at said outlet end a pressure effect is generated, said inlet end or said outlet end is in working-medium-conductive connection with said toroidal working chamber; and
said pump impeller is radially mounted, axially moveably and/or angularly tiltably, rotationally fixedly on said drive shaft.

12. The hydrodynamic machine according to claim 11, further comprising a stationary housing surrounding at least said vaned wheel driven by means of said drive shaft, and said pump impeller is axially mounted in said stationary housing.

13. The hydrodynamic machine according to claim 11, further comprising a curved-tooth coupling, said pump impeller is mounted on said drive shaft via said curved-tooth coupling.

14. The hydrodynamic machine according to claim 13, wherein said curved-tooth coupling has a first gear ring with external toothing and a second gear ring with internal toothing which surround each other in a radial direction so that said internal toothing meshes with said external toothing in a plane running perpendicular to or angled to the rotary axis, wherein one of said first and second gear rings is mounted on or configured integrally with said drive shaft and the other of said first and second gear rings is mounted on or configured integrally with said pump impeller.

15. The hydrodynamic machine according to claim 14, wherein said external toothing has teeth with a crowned tooth head.

16. The hydrodynamic machine according to claim 15, wherein said internal toothing has tooth gaps with a tooth base which is flat or rectilinear in a direction of the rotary axis.

17. The hydrodynamic machine according to claim 12, further comprising at least one slip ring, said pump impeller is sealed against said stationary housing by means of said at least one slip ring in an axial direction.

18. The hydrodynamic machine according to claim 17, wherein said slip ring is carried moveably in the axial direction by said pump impeller or said stationary housing.

19. The hydrodynamic machine according claim 18, wherein said slip ring is connected rotationally fixedly to said pump impeller or said stationary housing.

20. The hydrodynamic machine according to claim 18, wherein at least one of said slip ring or said pump impeller is made of plastic.

21. The hydrodynamic machine according to claim 11, wherein the hydrodynamic machine is a hydrodynamic retarder.

22. The hydrodynamic machine according to claim 13, wherein said curved-tooth coupling has a first gear ring with external toothing and a second gear ring with internal toothing which surround each other in a radial direction so that said internal toothing meshes with said external toothing in a plane running perpendicular to or angled to the rotary axis, wherein said first gear ring is mounted on or configured integrally with said drive shaft and said second gear ring is mounted on or configured integrally with said pump impeller.

23. The hydrodynamic machine according claim 18, wherein said slip ring is connected rotationally fixedly to said pump impeller or said stationary housing by form fit by means of at least one undercut.
